(19) United States
(12) Patent Application Publication
(10) Pub. No.: US 2002/0181729 A1
(43) Pub. Date: Dec. 5, 2002

(54) Hearing enhancement communication link

(76) Inventor: Richard C. Smith, Costa Mesa, CA (US)

Correspondence Address: MORLAND C FISCHER, 2030 MAIN ST, SUITE 1050, IRVINE, CA, 92614

(21) Appl. No.: 09/870,617

(22) Filed: Jun. 1, 2001

(51) Int. Cl. H04R 25/00

(52) U.S. Cl. 381/381; 381/384

(57) ABSTRACT

A hearing enhancement communication link within which a hearing aid speaker is connected, whereby to supply loud and clear audio messages over a full range of frequencies from a receiver/transmitter (e.g., a 2-way radio) directly to the ear of the user in order to overcome the adverse effects of loud background noises and/or a hearing impairment of the user. The hearing aid speaker is electrically connected to an electrical receptacle by an electrical cable having a pair of conductors running between the hearing aid speaker and the receptacle. The hearing aid speaker is acoustically coupled to an ear piece to be received in the user's ear by way of acoustic tubing. The electric cable has a coiled section to be stretched and provide strain relief to the conductors running through the cable. The acoustic tubing has a gentle bend to run behind and over the top of the user's ear to better hold the ear piece therein.

### BACKGROUND OF THE INVENTION

1. Field of the Invention

This invention relates to a hearing enhancement communication link within which a hearing aid speaker (e.g., a balanced armature micro-speaker) is connected whereby to supply loud and clear audio messages from a receiver/transmitter (e.g., a 2-way radio, cell phone or a Walkman type stereo player) directly to the ear of the user in order to overcome the adverse effects of loud background noises and/or a hearing impairment of the user.

2. Background Art

It is frequently necessary to transmit detailed audio messages directly to a recipient who is separated by a great distance from the source (e.g., a remote radio transmitter) of the messages. For example, law enforcement and security personnel working in the field are usually required to stay in constant contact with a central command station. Because of loud background noise in the vicinity of the user or where the user has a hearing impairment, he may not be able to understand vital communications that require immediate action. For example, police and military personnel often sustain partial hearing loss as a consequence of the nature of their work.

In cases where individuals are engaged in covert operations, they are often required to carry on their bodies a 2-way radio, or the like. In this regard, a relatively heavy and bulky button diaphragm speaker is typically coupled between an audio source and an ear piece. Not only does a diaphragm speaker increase the total weight of the communication path to be supported from the user's ear, but the diaphragm speaker is also characterized by a narrow and low frequency response range. This low frequency response range is further degraded, inasmuch as the diaphragm speaker is acoustically coupled to a coiled, collapsed acoustic tube that is known to inhibit the transmission of certain sounds (by as much as 15 decibels). Because of its relatively large size and weight, clips and other retaining means are often used to hold a diaphragm speaker against the user's clothing, such as at his collar. Notwithstanding these clips, it is still somewhat difficult to hold a diaphragm speaker in place, especially when the user is running or his head undergoes violent turns.

Those who suffer from high frequency hearing loss, may find it hard to clearly hear the messages that are relayed to their ears from a diaphragm speaker. That is, because our speech patterns involve changes in high frequency sounds, being unable to detect such high frequency fluctuations in speech can result in a missed communication and a possible injury or fatality as a result thereof. Accordingly, it would be desirable to replace the conventional button diaphragm speaker in a 2-way communication path by a lighter, more efficient speaker that is capable of providing clear messages to the ear of a user over a wide (i.e., high) frequency range.

### SUMMARY OF THE INVENTION

A hearing enhancement communication link is disclosed for use in a communication path between a transmitter/receiver (e.g., a 2-way radio) carried on the body of a user and an ear piece to be located within the ear of the user. The communication link of this invention has particular application for use by law enforcement, military and security personnel who wish to hear clear, covert audio messages that originate from a remote source. The audio communication link includes a hearing aid speaker that is electrically connected to a polarized plug or receptacle by which the hearing aid speaker can be interfaced with the aforementioned 2-way radio or a cell phone, a hand-held speaker, a Walkman type stereo player, and the like, depending upon the characteristics of the receptacle or plug. In one embodiment, the hearing aid speaker is electrically connected to a polarized receptacle by means of a 2-wire twisted cable that is surrounded by acoustic tubing for protection. In another embodiment, the hearing aid speaker is electrically connected to the polarized receptacle by means of a heavy duty, 2-wire coiled and straight cable. In a third embodiment, the hearing aid speaker is electrically connected to the polarized receptacle by means of light weight, 2-line coiled cable. In each case, the cables by which the hearing aid speaker and polarized receptacle are electrically connected together include a number of (e.g., at least eight) turns or coils to accommodate the movements of the user and provide strain relief for the fragile conductors of the cables. In still another embodiment, a pair of hearing aid speakers are electrically connected to a stereo plug or jack by way of an electrical Y and a section of straight electrical cable to form a headset of the type used with a stereo player.

The hearing aid speaker is acoustically coupled to an ear piece by way of a section of clear acoustic tubing and a rigid elbow. The ear piece may be either closed or opened and is adapted to hold the hearing aid speaker of the hearing enhancement communication link close to the user's ear. The acoustic tubing may contain a permanent gentle bend that extends from behind and over top of the user's ear to more reliably hold the ear piece in place.

In an alternate embodiment, the hearing enhancement communication link may be modularized by having hearing aid speaker and electrical cable sections detachably connected to one another. The hearing aid speaker section includes an electrical receptacle and a balanced armature micro-speaker surrounded by a protective speaker housing and coupled to an earpiece via a run of acoustic tubing. The electrical cable section includes a complementary plug that is detachably connected at one end thereof to the receptacle of the hearing aid speaker section and at the opposite end to any suitable electrical plug or receptacle depending upon the application of the communication link.

By virtue of using the hearing aid speaker as herein disclosed, the overall size and weight of the hearing enhancement communication link can be minimized. In addition, the hearing aid speaker may be inconspicuously carried at the front or back of the user's ear and need not be clipped to the user's clothing. What is more, the hearing aid speaker is capable of providing a wider (i.e., higher) frequency response relative to the characteristics of a conventional button diaphragm speaker. This is particularly significant to those individuals who have suffered high frequency hearing loss while on the job. Accordingly, the user will be able to hear loud, clear and covert (i.e., not for public broadcast) audio messages over a full frequency range whether working indoors, out of doors, or in an undercover operation.

### BRIEF DESCRIPTION OF THE DRAWINGS

FIG. 1 shows a hearing enhancement communication link according to a first embodiment of my invention connected in a communication path between a 2-way radio and an ear piece;

FIG. 2 is a detailed illustration of the hearing enhancement communication link of FIG. 1;

FIG. 3 shows a hearing enhancement communication link according to a second embodiment of my invention;

FIG. 4 shows a hearing enhancement communication link according to a third embodiment of this invention;

FIG. 5 shows a modification to the hearing enhancement communication links of FIGS. 2-4; and

FIG. 6 shows an alternate embodiment and use of my invention for a stereo headset.

### DETAILED DESCRIPTION

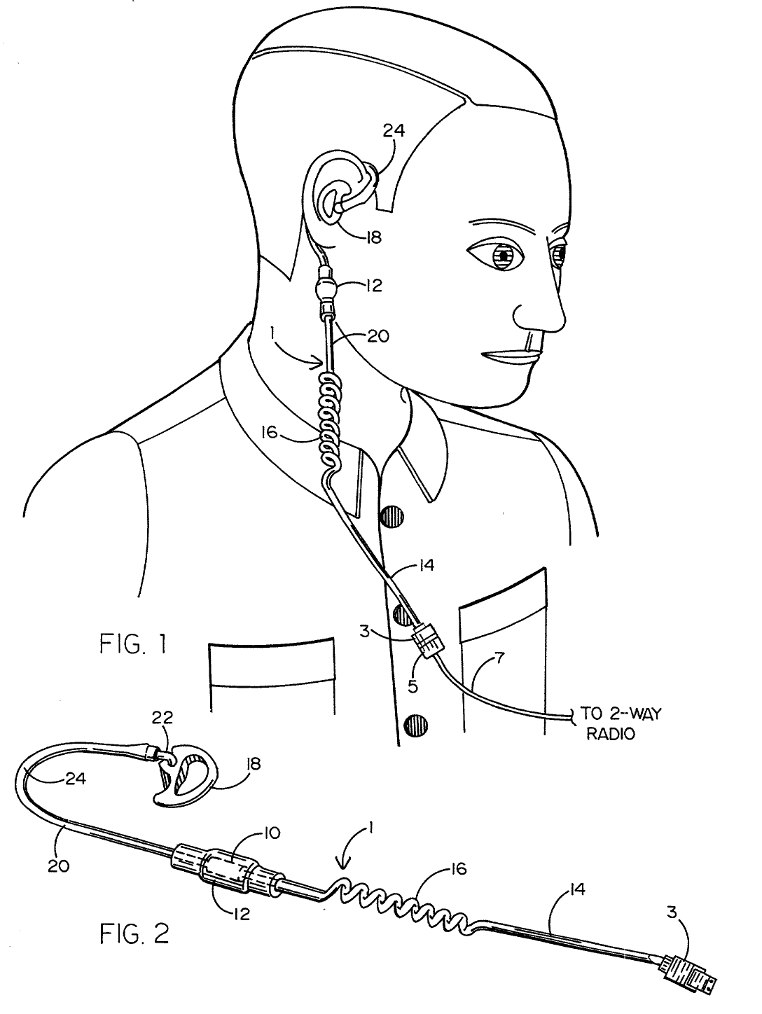

A hearing enhancement communication link 1 according to a first embodiment of this invention is described while referring to FIGS. 1 and 2 of the drawings. The hearing enhancement communication link of this and the soon to be described other embodiments have particular advantage for delivering directly to the ear of a user loud and clear audio messages that are to be transmitted from such audio sources as a 2-way radio, a cell phone, and the like. The communication links to be described below enable the user to hear the message, including high frequency sounds that give meaning to human speech patterns, in noisy environments and in undercover situations where the message is not intended for broadcast to the public. Therefore, my invention has particular application for use by law enforcement, general aviation, military and security personnel who are engaged in covert operations or who wish to remain inconspicuous in a crowd while being able to receive undistorted messages from a distant command center despite ambient noise conditions or partial hearing loss. In addition, my invention may also be used for civilian and commercial applications including movie and music studios and stage and theatrical performers.

The hearing enhancement communication link 1 of FIGS. 1 and 2 includes a conventional 2-hole polarized receptacle 3 at one end thereof. Such a receptacle is sometimes known as a universal type “257” in-line plug. Receptacle 3 is adapted to be connected to a complementary polarized 2-way radio plug (designated 5 in FIG. 1) that runs to a 2-way radio (not shown) to be carried on the body of the user. The radio plug 5 is connected to the 2-way radio by the usual radio cable 7. However, it is to be understood that the receptacle 3 can also be coupled to other audio signal transmitter/receiver sources, such as a cell phone, telephone, walkie-talkie, etc.

As an important feature of the hearing enhancement communication link 1, the polarized receptacle 3 is electrically connected to a conventional hearing aid speaker 10, such as an amplified balanced-armature micro transducer. A commercially available hearing aid speaker that is suitable for use herein is a Series BK unit manufactured by Knowles. For protection from the elements, the hearing aid speaker 10 is shown in the drawings having an outer protective (e.g., rubber) sleeve 12 heat shrunk therearound. The hearing aid speaker 10 described above eliminates the need for cumbersome restraining clips and advantageously provides a wider (i.e., higher) frequency response compared with the rather heavy and bulky diaphragm speaker that has heretofore been commonly used in conventional audio communication links.

By way of example, the hearing aid speaker 10 and the polarized receptacle 3 are electrically connected together by means of small 2-wire twisted cable (not shown) that is surrounded and protected by a section of clear acoustic tubing 14. The acoustic tubing 14 has a coiled portion 16 that may be stretched to accommodate the movements of the user and provide strain relief for the twisted cable running therethrough. It has been found that a coiled portion 16 having at least eight turns will provide the user with sufficient freedom of motion to meet most requirements in the field.

The hearing aid speaker 10 is acoustically coupled to an open ear piece 18 by way of another section of clear acoustic tubing 20. The acoustic tubing 20 is connected to the ear piece 18 by a rigid acoustic elbow 22 or any other suitable fitting. Any ear piece 18 may be used to hold the hearing enhancement communication link 1 to the ear of the user. However, for purposes of example, the open ear piece shown in FIGS. 1 and 2 is the lightweight, comfortable and flexible ear piece that has been disclosed and claimed in my pending patent application Ser. No. 09/767,808 filed Jan. 24, 2001. Although my ear piece 18 has both a unique ornamental shape, as well as structural features that will prevent it from accidentally falling out of the user's ear, the section of acoustic tubing 20 may contain a gentle bend 24 so as to extend from behind and over top of the ear to more reliably hold the ear piece 18 in place, whereby the hearing and speaker will be positioned behind the user's ear.

By virtue of locating the hearing aid speaker 10 between the polarized receptacle 3 and the ear piece 18 at opposite ends of the hearing enhancement communication link 1, the user will be able to hear messages more clearly than had a conventional button diaphragm speaker been used. Moreover, the total weight of the communication link 1 having hearing aid speaker 10 connected therein will be reduced relative to conventional links in which a diaphragm speaker is located so as to improve comfort, especially when the ear piece is to be worn for a long period of time.

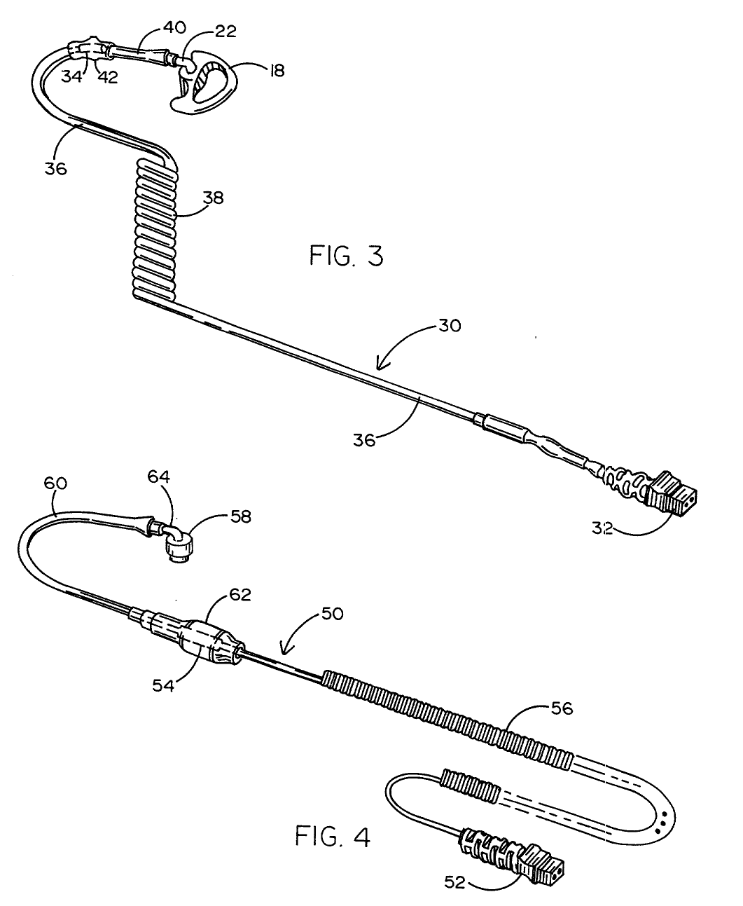

FIG. 3 of the drawings shows a hearing enhancement communication link 30 according a second embodiment of my invention. Located at one end of the communication link 30 is a polarized 2-hole receptacle 32 that is adapted to be connected to a complementary polarized 2-way radio plug (not shown). The polarized receptacle 32 is electrically connected to a hearing aid speaker 34 by way of a long continuous length of heavy duty, 2-wire cable 36. Such heavy duty cable 36 is especially suited for use by the military or in a rugged out of doors location. Cable 36 includes a coiled section 38 to provide the same advantages that are available from the coiled acoustic tubing 16 of the communication link 1 of FIG. 2. The cable 36 runs for about 30 cm between plug 32 and hearing aid speaker 34 when coiled section 38 is in the relaxed (i.e., unstretched) configuration shown in FIG. 3.

In the case of the hearing enhancement communication link 30 of FIG. 3, the hearing aid speaker 34 is acoustically coupled to the ear piece 18 by means of a short (about 1.25 cm) length of acoustic tubing 40 and a rigid elbow 22. Like the hearing aid speaker 10 of FIG. 2, the hearing aid speaker 34 is surrounded by an outer sleeve 42 that is heat shrunk therearound. The hearing aid speaker 34 of communication link 30 is of small size so as to be capable of fitting immediately behind the elbow 22 and in close proximity to the ear piece 18. A relatively small commercially available hearing aid speaker that is suitable for use herein is a Series ED unit manufactured by Knowles.

By virtue of its small size and its position in the hearing enhancement communication link 30 of FIG. 3 between the end of cable 36 and the elbow 22, the hearing aid speaker 34 can be inconspicuously carried in front of the user's ear when the ear piece 18 is worn so that covert or silent messages can be received directly in the ear of the user. Accordingly, those users with high frequency hearing loss and other impairments will be better able to hear and understand a full range of audio messages that are transmitted over the communication link 30 from a 2-way radio, or the like.

FIG. 4 of the drawings shows a hearing enhancement communication link 50 according to another embodiment of my invention. Located at one end of the communication link 50 is a polarized 2-hole receptacle 52 that is adapted to be connected to a complementary polarized 2-way radio plug (not shown). The polarized receptacle 52 is electrically connected to a hearing aid speaker 54 by way of a relatively long length (e.g., about 12 cm) of light weight, tightly wound 2-line coiled electric cable 56. The coiled cable 56 provides the same freedom of movement and strain relief advantages that have been previously described when referring to the coiled sections of the hearing enhancement communication links 1 and 30 of FIGS. 2 and 3.

The hearing aid speaker 54 of the communication link 50 of FIG. 4 is of light weight such that the combination of the light weight coiled cable 56 and hearing aid speaker 54 enables the hearing enhancement communication link 50 to be characterized by a relatively light total weight (about 0.3 ounces) so as to be comfortably carried in the ear of a user. A commercially available light weight hearing aid speaker that is suitable for use herein is a Series BC unit manufactured by Knowles.

In the case of the hearing enhancement communication link 50 of FIG. 4, the hearing aid speaker 54 is acoustically coupled to the ear piece 58 by means of a section of clear acoustic tubing 60. The hearing aid speaker 54 is surrounded by an outer sleeve 62 that is heat shrunk therearound. The section of acoustic tubing 60 by which the hearing aid speaker 54 is coupled to the ear piece 58 may contain a gentle bend so as to extend behind and over top of the user's ear to better hold the ear piece 58 in place in the same manner as illustrated in FIG. 1.

The section of acoustic tubing 60 is connected to the ear piece 58 by means of a rigid elbow 64. By way of example, the ear piece 58 in the hearing enhancement communication link 50 of FIG. 4 is a closed ear piece that will hold the hearing aid speaker 54 behind the user's ear. Such an ear piece 58 is advantageous for providing maximum noise attenuation. Of course, other ear pieces, such as the open ear piece designated by reference numeral 18 in FIGS. 1-3 may be substituted for the closed ear piece 58 of FIG. 4.

The hearing enhancement communication links 1, 30 and 50 in which a hearing aid speaker is electrically connected to an in-line receptacle 30, 32 and 52 are shown as being interfaced with a 2-way radio. However, and as illustrated in FIG. 6, the in-line electrical receptacles can be replaced by different plugs (e.g., a musical or cell phone plug), whereby the hearing aid speakers of communication links 1, 30 and 50 can be coupled over a communication path to a cell phone, a Walk-Man type stereo player, a hand held computer, and other sources of audio information that is to be transmitted to the ear of a user.

It may now be appreciated that in the hearing enhancement communication link 1 of FIGS. 1 and 2, the hearing aid speaker 10 is electrically connected to in-line receptacle 3 via a 2-wire twisted cable surrounded by acoustic tubing 4. In the communication link 30 of FIG. 3, the hearing aid speaker 34 is electrically connected to in-line receptacle 32 via heavy duty 2-wire cable 36. In the communication link 50 of FIG. 4, the hearing aid speaker 54 is electrically connected to the in-line receptacle 52 via light weight 2-line coiled cable 56. Acoustically coupling the hearing aid speakers 10, 34 and 54 to an ear piece via a relatively short length of acoustic tubing 20, 40 and 60 (when compared with the longer length of the electric cables) maximizes power in the high frequency range of the audio message. Moreover, the message must only travel a short distance to the user's ear with less chance of introducing distortion. Thus, any of the relatively small size and light weight communication links disclosed above can be reliably used for a variety of different military, law enforcement and civilian purposes, depending upon whether the user will be engaged in undercover covert work, working in a rugged environment, performing an activity that subjects his head to violent turns, or simply resting comfortably at home.

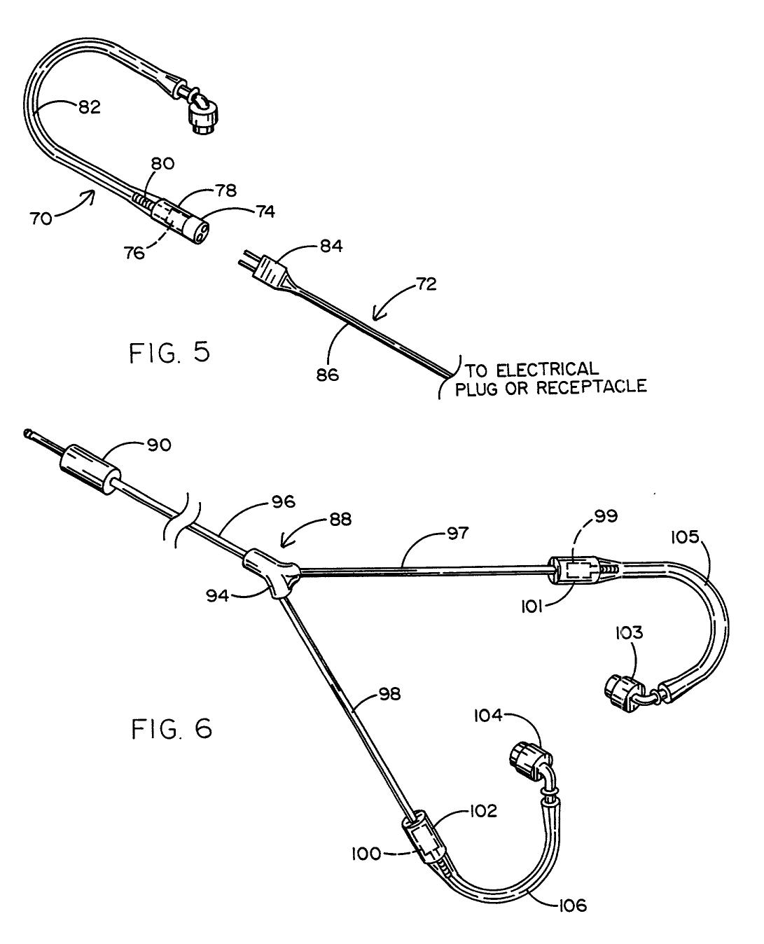

FIG. 5 of the drawings shows a modification to the hearing enhancement communication links 1, 30 and 50 that are shown in FIGS. 2, 3 and 4. In each of the communication links 1, 30 and 50 described above, a hearing aid speaker is connected directly (e.g., hard wired) to an electrical receptacle by way of a section of straight and/or coiled electrical cable. The modification shown in FIG. 5 enables the hearing aid speaker to be detached from the receptacle at the end of the electrical cable run. By virtue of the foregoing, it will be easier to package a communication link having separate hearing aid speaker and electrical cable sections 70 and 72. More importantly, a modularized hearing enhancement communication link may be manufactured that permits the hearing aid speaker to be disconnected from one type of electrical plug (e.g., such as the type 257 polarized receptacle designated 3, 32 and 52 in FIGS. 2, 3 and 4) and reconnected to a different type of plug or receptacle (e.g., such as the stereo plug designated 90 in FIG. 6), whereby to advantageously increase the applications for my invention without requiring the user to purchase separate communication links depending upon the source of the audio signals to be transmitted to his ear.

In FIG. 5, the modular hearing aid speaker section 70 can be substituted for the hearing aid speaker in any of the communication links 1, 30 and 50 of FIGS. 2, 3 and 4. Hearing aid speaker section 70 includes a type 257 in-line 2-hole electrical receptacle 74. A hearing aid speaker 76 is electrically connected to receptacle 74. In this embodiment, the hearing aid speaker 76 is preferably a balanced armature micro-speaker, such as a Series CI unit manufactured by Knowles. The electrical receptacle 74 and hearing aid micro-speaker 76 are surrounded by a protective speaker housing 78 which is manufactured from an impact resistant metal or plastic.

The hearing aid micro-speaker 76 is interfaced with an acoustic tubing coupler 80 which projects outwardly from the speaker housing 78 to be acoustically coupled to a run of gently bent acoustic tubing 82 that is shaped to fit over the user's ear. The acoustic tubing coupler 80 may have an enlarged head or a threaded of knurled surface by which one end of the run of acoustic tubing 82 is reliably attached to coupler 80 by means of either a screw on or direct plug in connection. The opposite end of the run of acoustic tubing 82 is connected to a suitable ear piece (not shown) such as that designated 18 or 58 in FIGS. 2, 3 and 4.

The modular electrical cable section 72 of FIG. 5 includes a two-way radio plug 84 having the usual pair of pins that are adapted to be removably received by the 2-hole electrical receptacle 74 of the hearing aid speaker section 70. The plug 84 is connected via a 2-wire cable section 86 to a suitable electrical receptacle or plug (not shown), such as that designated 3, 32, 52 or 90 in FIGS. 2, 3, 4, and 6. Accordingly, with the plug 84 and receptacle 86 connected together, audio signals can be delivered directly to the ear of a user via the modularized detachable hearing aid speaker and electrical cable sections 70 and 72.

Turning now to FIG. 6 of the drawing, an alternate embodiment is described for my invention shown in FIGS. 1-5. In the embodiment of FIG. 6, the previously described advantage of a hearing aid communication link having a hearing aid speaker electrically and acoustically connected therewithin is employed by a head set 88 of the type that is often used with a commercially available audio/stereo source known as a Walkman, or similar player. In this case, the headset 88 has a standard stereo plug 90 that is connected to an electrical Y 94 by way of a section of straight 2-wire electrical cable 96. However, the plug 90 can be any 2.5 or 3.5 stereo or mono plug or jack. The cable 96 is bifurcated at the electric Y 94 by which two independent runs 97 and 98 of 2-wire electrical cable are established. Each run of electrical cable 97 and 98 is connected to a respective hearing aid speaker 99 and 100 that is surrounded by an outer protective casing 101 and 102. The hearing aid speakers 99 and 100 may be the same balanced armature micro-speaker that was previously described when referring to FIG. 5. Hearing aid speakers 99 and 100 are then acoustically coupled to respective ear pieces 103 and 104 via gently bent sections of acoustic tubing 105 and 106 and elbows (not shown). Each ear piece 103 and 104 is preferably the same closed earpiece (designated 58) as that shown in FIG. 4. The runs of acoustic tubing 105 and 106 are shaped to fit over the user's ears and hold the hearing aid speakers behind the ear.

Accordingly, by connecting the hearing aid speakers 99 and 100 between the electrical cables 97 and 98 and the ear pieces 103 and 104 by way of the runs of acoustic tubing 105 and 106, the user of headset 88 will be able to receive loud and clear audio signals (e.g. prerecorded music) from his Walkman or similar stereo type player whether at home or on the road.

I claim:

1. A hearing enhancement communication link having an electrical receptacle at one end thereof to be interfaced with a source of audio signals, an ear piece at the opposite end to be received in the ear of a user, and a hearing aid speaker electrically connected to said electrical receptacle and acoustically coupled to said ear piece, said hearing aid speaker receiving an audio output from said source and providing a relatively loud and clear representation of said audio output to the ear of the user by way of said ear piece.

2. The hearing enhancement communication link recited in claim 1, wherein said hearing aid speaker is electrically connected to said electrical receptacle by means of an electrical cable having a pair of conductors running through said electrical cable between said hearing aid speaker and said electrical plug.

3. The hearing enhancement communication link recited in claim 2, wherein said electrical cable connected between said hearing aid speaker and said electrical receptacle has a plurality of coils to enable said electrical cable to stretch and thereby provide strain relief and prevent possible damage to said pair of conductors running through said electrical cable.

4. The hearing enhancement communication link recited in claim 3, wherein said electrical cable has at least eight coils to enable said cable to be stretched.

5. The hearing enhancement communication link recited in claim 1, wherein said hearing aid speaker is surrounded by an outer protective sleeve.

6. The hearing enhancement communication link recited in claim 1, wherein said hearing aid speaker is acoustically coupled to said ear piece by means of acoustic tubing.

7. The hearing enhancement communication link recited in claim 6, wherein said acoustic tubing has a permanent bend formed therein that is sized to run from behind and over top of the user's ear to thereby better hold said ear piece within the ear of the user.

8. The hearing enhancement communication link recited in claim 6, wherein said acoustic tubing is acoustically coupled to said ear piece by means of a rigid elbow extending between said acoustic tubing and said ear piece.

9. The hearing enhancement communication link recited in claim 1, wherein said hearing aid speaker is located closer to said ear piece than to said electrical plug so as to be held adjacent the user's ear when said ear piece is received therein.

10. The hearing enhancement communication link recited in claim 1, wherein said hearing aid speaker is detachably connected to said electrical receptacle.

11. The hearing enhancement communication link recited in claim 10, wherein said hearing aid speaker is a balanced armature micro-speaker.

12. The hearing enhancement communication link recited in claim 10, including first and second electrical connectors, said first electrical connector electrically connected to said hearing aid speaker, and said second electrical connector electrically connected to said electrical receptacle and adapted to be detachably connected to said first electrical connector.

13. A hearing enhancement communication link having an electrical receptacle at one end thereof to be interfaced with a source of audio signals, an ear piece at the opposite end to be received in the ear of a user, a hearing aid speaker acoustically coupled to said ear piece, an electrical cable having a pair of conductors running through said electrical cable between said hearing aid speaker and said electrical receptacle, said electrical cable having a plurality of coils to enable said electrical cable to stretch and thereby provide strain relief and prevent possible damage to said pair of conductors running through said electrical cable, and acoustic tubing by which to acoustically couple said hearing aid speaker to said ear piece, said acoustic tubing being shorter in length than said electric cable such that said hearing aid speaker is located in close proximity to said ear piece, said hearing aid speaker receiving an audio output from said source via said electrical cable and providing a relatively loud and clear representation of said audio output to the ear of the user via said acoustic tubing and said ear piece.

14. The hearing enhancement communication link recited in claim 13, wherein said hearing aid speaker is detachably connected to said electrical cable and to the pair of conductors running therethrough to said electrical receptacle.

15. First and second hearing enhancement communication links having first and opposite ends to be connected at the first ends thereof to a source of audio signals, each of said first and second hearing enhancement communication links having an earpiece at the opposite end thereof to be received in an ear of a user, a hearing aid speaker located between said first and opposite ends, acoustic tubing by which said hearing aid speaker is acoustically coupled to said earpiece, and electrical cable by which said hearing aid speaker is electrically connected to said source of audio signals, said hearing aid speaker receiving an audio output from said source and providing a relatively loud and clear representation of said audio output to the ear of the user by way of said acoustic tubing and said earpiece.

16. The first and second hearing enhancement communication links recited in claim 15, wherein the first ends of said first and second hearing enhancement communication links are electrically connected together at a plug, whereby to form a stereo headset.
